(19) United States
(12) Patent Application Publication
(10) Pub. No.: US 2012/0143703 A1
(43) Pub. Date: Jun. 7, 2012

(54) MULTIPLE CONTACTLESS DEVICE INTERACTIONS AND COMMUNICATION PROTOCOLS PER TAP

(75) Inventors: Jonathan Wall, San Francisco, CA (US); Rob von Behren, Berkeley, CA (US)

(73) Assignee: GOOGLE Inc., Mountain View, CA (US)

(21) Appl. No.: 13/246,076

(22) Filed: Sep. 27, 2011

Related U.S. Application Data
(60) Provisional application No. 61/419,799, filed on Dec. 3, 2010.
(60) Provisional application No. 61/535,507, filed on Sep. 16, 2011.

(51) Int. Cl. H04B 5/00

(52) U.S. Cl. 705/16; 455/41.1

(57) ABSTRACT

Enabling multiple contactless interactions and communication protocols with a single tap of a contactless device. A device reader generates a polling loop and detects a contactless device using an RF field. The device reader identifies the contactless device's communication protocols and initiates a first communication protocol via ISO/IEC 18092 protocol. The device reader initiates a stored value communication via MIFARE protocol. The device reader then initiates an EMV communication via ISO/EIC 14443 protocol. A contactless device can function for both an EMV compliant payment transaction and an alternative peer-to-peer type transaction. The EMV based payment application and transaction is retained as an independent payment application, thereby keeping the additional data exchange process of EMV technology from influencing the peer-to-peer technology and avoiding re-certification of EMV technology.

### RELATED APPLICATIONS

This application claims priority to U.S. Provisional Patent Application No. 61/419,799, filed Dec. 3, 2010 and entitled “Multiple Interaction Per Tap Contactless Payment System” and U.S. Provisional Patent Application No. 61/535,507, filed Sep. 16, 2011 and entitled “Multiple Contactless Device Interactions and Communication Protocols Per Tap.” The entire contents of each of the above-identified priority applications are hereby fully incorporated herein by reference.

### TECHNICAL FIELD

The present disclosure relates generally to contactless devices, and more particularly to methods and systems that allow for multiple interactions and communication protocols with a single contactless payment device tap.

### BACKGROUND

Contactless device technology incorporates proximity communications between two devices to authenticate and enable payment for goods and services over the air (OTA) or without physical connection. Near Field Communication (NFC) is an example of a proximity communication option that can enable contactless device payment technologies and that is supported by the Global System for Mobile Communications (GSM) Association. RFID is an example of a proximity communication method that can be adapted to enable NFC contactless device payment technology. NFC communication distances generally range from about 3 to about 4 inches. Such short communication distances enable secure communication between close field proximity enabled devices.

In GSM phones, a proximity-enabled controller (for example, an NFC controller) with an antenna is incorporated into the contactless device with the secure contactless software applications located on a smart chip. An NFC-enabled contactless payment device enables financial transactions, ticketing, secure authentication, coupons, and other transaction for the device owner.

Point of sale device readers designed to communicate with these contactless devices are limited in design to support particular NFC communication types and standards. For instance, many device readers are limited by design to support ISO/IEC 14443 type A and/or B technology for secure payment transactions based on EMV contactless communication protocols. Communication speed for these transactions is limited to 186 kbits/s, not allowing for richer communication paradigms. Other device readers utilize higher bit rates, but are limited to non-payment transactions, for example, MIFARE smart cards.

### SUMMARY

In certain exemplary aspects, a method of allowing multiple interactions and communication protocols with a single tap can include a device reader that facilitates multiple, automatic, convenient, and secure communications with a contactless device. The device reader generates a polling loop and detects a contactless device using a radio frequency (RF) field. Once a communication channel is established with a single contactless device and the device's communication protocols and characteristics are determined, the device reader initiates the first communication protocol. In an exemplary embodiment, the device reader communicates first using the standard ISO/IEC 18092, then using the standard MIFARE, and finally using the standard ISO/EIC 14443, if needed. In another embodiment, the device reader communicates first using MIFARE and then using ISO/EIC 14443. The device reader selects an application from the contactless device using the first communication protocol, and the application processes the first communication. The device reader then selects an application from the contactless device using the second communication protocol, and the application processes the second communication. In another embodiment, the device reader selects an application from the contactless device using a third communication protocol, and the application processes the third communication.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting an operating environment for a multiple interactions per tap contactless payment system according to an exemplary embodiment.

FIG. 2 is a block flow diagram depicting a method for contactless device discovery according to an exemplary embodiment.

FIG. 3 is a block flow diagram depicting a method for identifying contactless device communication protocols according to an exemplary embodiment.

FIG. 4 is a block flow diagram depicting a method for communication when the ISO 18092 protocol is available according to an exemplary embodiment.

FIG. 5 is a block flow diagram depicting a method for communication when the MIFARE protocol is available according to an exemplary embodiment.

FIG. 6 is a block flow diagram depicting a method for communication when the ISO 14443 protocol is available according to an exemplary embodiment.

### DETAILED DESCRIPTION OF EXEMPLARY EMBODIMENTS

### Overview

The exemplary embodiments provide methods and systems that enable multiple contactless interactions and communication protocols with a single “tap” of a contactless device with a contactless device reader. The device reader generates a polling loop and detects a contactless device using an RF field. NFC technology enables data transmission between the contactless device and the device reader when they are brought within a few inches of one another for a tap. A communication channel is established between the contactless device and the device reader. The device reader requests the contactless device's communication protocols and characteristics, and the contactless device responds. This process is repeated at least one time to ensure all contactless devices are detected. If multiple devices are detected, the device reader resets the RF field and repeats the process until only a single contactless device is detected.

The device reader identifies the contactless device's communication protocols and initiates the first communication protocol. The device reader looks first for an ISO/IEC 18092 communication protocol. If it is found, the device reader initiates a peer-to-peer communication using the ISO/IEC 18092 protocol. Many value-add service options are available using this peer-to-peer communication. The device reader then looks for a MIFARE communication protocol. If it is found, the device reader initiates a stored value and/or limited value-add services communication using the MIFARE protocol. The device reader may then look for an ISO/EIC 14443 communication protocol. If it is found, the device reader initiates an EMV communication using the ISO/IEC 14443 protocol. If an ISO/IEC 18092 communication protocol is not found, the device reader will look for a MIFARE communication protocol and then an ISO/IEC 14443 communication protocol.

The exemplary embodiment allows for a contactless device to function for both an EMV compliant payment transaction and one or more alternative peer-to-peer type transactions, which transactions may be completed in a single tap of the contactless device with the device reader. The EMV based payment application and transaction is retained as an independent payment application, thereby keeping the additional data exchange process of EMV technology from influencing the peer-to-peer technology and avoiding re-certification of EMV technology.

In an exemplary embodiment, the device reader looks to communicate first using the standard ISO/IEC 18092 and then generates a secondary polling loop to communicate through a second standard (for example MIFARE and/or the standard ISO/EIC 14443). In an exemplary embodiment, the device reader communicates first using the standard ISO/IEC 18092, then using the standard MIFARE, and finally using the standard ISO/EIC 14443, if needed. In another exemplary embodiment, the device reader communicates first using MIFARE and then using ISO/EIC 14443. In an alternative exemplary embodiment, the device reader communicates first using the standard ISO/EIC 18092 and then using ISO/EIC 14443 and finally using MIFARE. In an exemplary embodiment, the device reader can communicate using ISO/EIC 18092, MIFARE and/or ISO/EIC 14443 in any specified order.

In an alternative embodiment, the device reader does not have a specific order of communication methods. Instead, the device reader communicates via the methods in any order. The device reader begins communicating via the first communication method and is then provided with a prompt to look for the next communication method.

In an exemplary embodiment, multiple interactions or applications may be processed using each communication method (ISO/EIC 18092, MIFARE and/or ISO/EIC 14443). For example, multiple value-added services may be processed at the same time using ISO/EIC 18092 or MIFARE, resulting in the processing of a multiple applications at the same time or the processing of multiple applications, one after another via the same communication method.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as the act may be performed by more than one computer. The functionality of the exemplary embodiments will be explained in more detail in the following description, read in conjunction with the figures illustrating the program flow.

### System Architecture

Turning now to the drawings, in which like numerals indicate like (but not necessarily identical) elements throughout the figures, exemplary embodiments are described in detail.

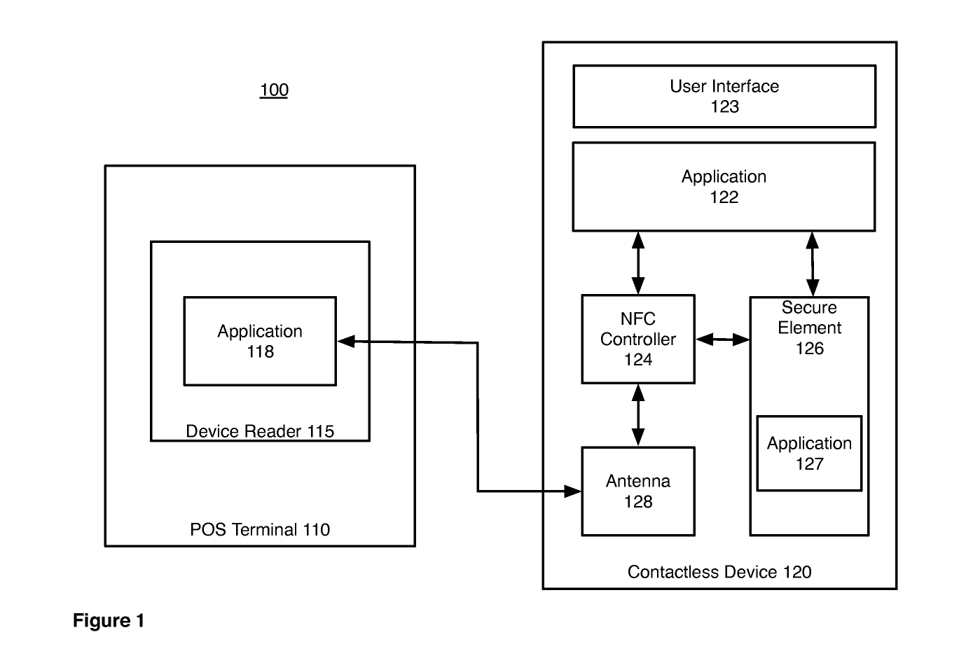

FIG. 1 is a block diagram depicting an operating environment 100 for a multiple interactions per tap contactless payment system according to an exemplary embodiment. As depicted in FIG. 1, the exemplary operating environment 100 includes a merchant point of sale (POS) terminal system 110 and a contactless device system 120 that are configured to communicate with one another via one or more communication protocols/standards (not shown).

In an exemplary embodiment, the communication protocols include, but are not limited to ISO/IEC 14443 type A and/or B technology (hereafter “ISO 14443”), MIFARE technology (hereafter “MIFARE”), and/or ISO/IEC 18092 technology (hereafter “ISO 18092”). ISO 14443 is a communication protocol for contactless devices operating in close proximity with a reader. An ISO 14443 communication protocol is utilized for secure card payments, including but not limited to credit card payments, debit card payments, and other forms of financial card payments. MIFARE is a communication protocol for contactless devices that comply with proprietary device standards that are based on ISO 14443. A MIFARE protocol is utilized for stored function transactions, including but not limited to gift cards, transit cards, tickets, access cards, loyalty cards, and other forms of stored value card transactions. A MIFARE protocol may also be used for limited value-added services. ISO 18092 is a communication protocol for contactless devices operating at higher bit rates, allowing for richer communication between the devices. An ISO 18092 communication protocol is utilized for peer-to-peer communication, value-added services (including, but not limited to, coupons, loyalty cards, check-ins, membership cards, gift cards, and other forms of value-added services), and other forms of richer communication.

The POS terminal system 110 includes a device reader 115 that is capable of communicating with the contactless device system 120 and the merchant POS terminal 110 via an application 118. In an exemplary embodiment, the proximity payment service environment (PPSE) is the application 118 selected by the device reader 115 when the contactless device 120 is presented to the device reader 115 and an ISO 14443 communication is initiated.

In an exemplary embodiment, the device reader 115 includes hardware and software to support EMV and peer-to-peer applications 118. Europay, MasterCard and VISA (EMV) is a standard for authenticating credit and debit card transactions. These standards are based on ISO 14443 for contactless payment transactions. Because card transactions can still be processed using ISO 14443, the integration of the peer-to-peer functionality will not lead to a requirement of EMV terminal re-certification.

In an exemplary embodiment, a contactless device system 120 can refer to a smart device that can communicate via an electronic and/or magnetic field between the device and another device, such as the terminal reader 115. In an exemplary embodiment, the contactless device 120 has processing capabilities, such as storage capacity/memory and one or more applications that can perform a particular function. In an exemplary embodiment, the contactless device 120 includes an operating system and a user interface 123. Examples of contactless devices 120 include smart phones; mobile phones; personal digital assistants (PDAs); mobile computing devices, such tablet computers, netbooks, and iPads; other electronically enabled key fobs; electronically enabled credit card type cards; and other devices. Certain contactless devices 120 can be used for multiple purposes, including financial transactions, coupons, ticketing, loyalty rewards, secure authentication, and related applications.

The contactless device 120 comprises a secure element 126. In certain exemplary embodiments, SIM cards may be capable of hosting the secure element 126, for example, an NFC SIM Card. In alternative exemplary embodiments, the secure element 126 my be part of a chip included in the contactless device 120. The secure element 126 includes components typical of a smart card, such as crypto processors and random generators. In an exemplary embodiment, the secure element 126 comprises a Smart MX type NFC controller 124 in a highly secure system on a chip controlled by a smart card operating system such as a JavaCard Open Platform (JCOP) operating system. In another exemplary embodiment, the secure element 126 is configured to include a non-EMV type contactless smart card as an optional implementation.

The secure element 126 communicates with an NFC controller 124 and the application 122 in the contactless device 120. In an exemplary embodiment, the secure element 126 is capable of storing encrypted user information and only allowing trusted applications to access the stored information. The NFC controller 124 provides a secure key encrypted application 122 for decryption and installation in the secure element 126.

The application 122 is a program, function, routine, applet, or similar entity that exists on and performs its operations on a contactless device 120.

The contactless device 120 communicates with the terminal reader 115 via the antenna 128. When the contactless device application 122 has been activated and prioritized, the NFC controller 124 is notified of the state of readiness of the contactless device 120 for a transaction. The NFC controller 124 polls through the antenna 128 a radio signal, or listens for radio signals from the device reader 115.

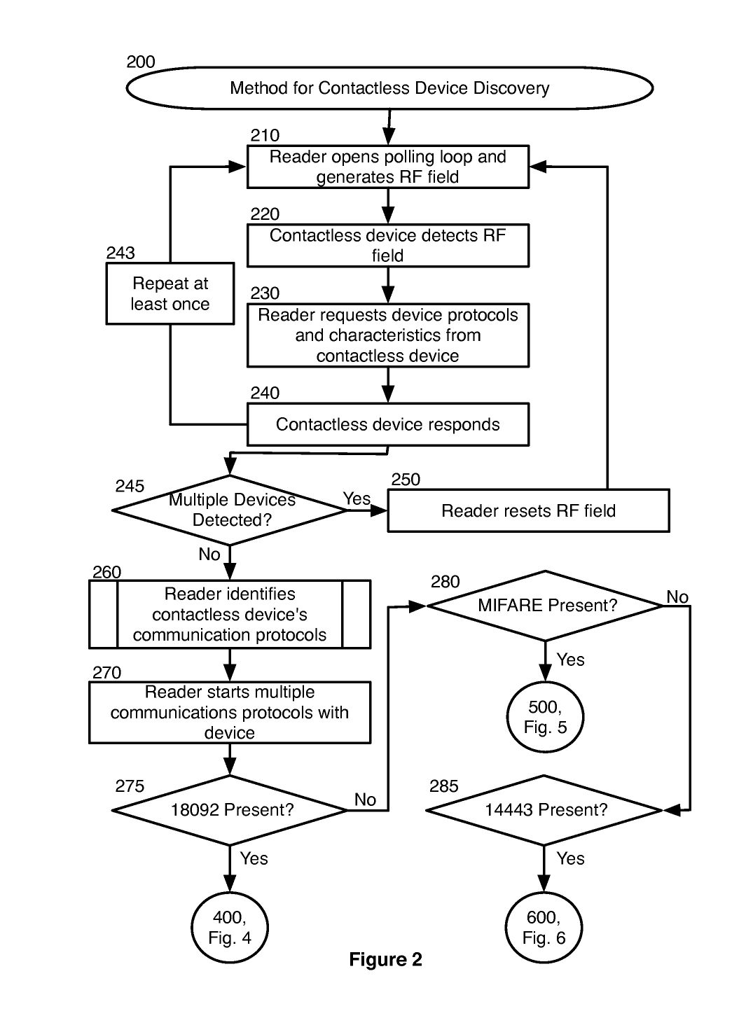

Upon establishing a channel between the contactless device 120 and the device reader 115, the device reader 115 requests to see the list of available applications 122 from the secure element 126. A directory is first displayed, after which, based on the set priority or the type of device reader 115, an application 122 is chosen and initiated for the transaction. The discovery of and communication with a contactless device is described in more detail hereinafter with reference to the methods described in FIGS. 2-6.

### System Process

FIG. 2 is a block flow diagram depicting a method for contactless device discovery according to an exemplary embodiment. The method 200 is described with reference to the components illustrated in FIG. 1.

In block 210, the device reader 115 opens a polling loop and generates a radio frequency (RF) field, continuously polling for the presence of a contactless device 120.

When the contactless device 120 is placed within the RF field of the device reader 115, the contactless device 120 detects the RF field generated by the device reader 115 at block 220. Then, a communication channel between the devices 115 and 120 is established. In an exemplary embodiment, the contactless device 120 is tapped in close proximity to the device reader 115 to enable detection of the RF field. In an certain exemplary embodiments, the systems and methods described herein are performed while the contactless device 120 is tapped.

The device reader 115 request protocols and characteristics from the contactless device at block 230. In an exemplary embodiment, the device reader 115 requests identify of the communication protocols (for instance ISO 14443, MIFARE, and/or ISO 18092) and a list of applications 122 available from the contactless device 120.

In block 240, the contactless device 120 responds with a list of communication protocols and applications available.

In an exemplary embodiment for communication, the device reader 115 generates an operating field, such as an RF field, and sends a command to the contactless device 120. The device reader 115 then switches off the operating field and the contactless device 120 generates its own operating field, sending commands and/or responses to the device reader 115. The contactless device 120 then switches off the operating filed. This process can be repeated as needed.

In another embodiment, the device reader 115 generates an operating field, such as an RF field, and sends a command to the contactless device 120. The contactless device 120 responds without generating its own operating field. This process can be repeated as needed.

The device reader 115 repeats the polling loop at least once at block 243 by resetting the RF field and repeating the above steps illustrated in blocks 210-240 to locate all contactless devices and all communication protocols.

After repeating the polling loop, the method 200 proceeds to block 245 to determine whether the device reader 115 has detected multiple contactless devices. If multiple contactless devices are detected by the device reader 115, the reader resets the RF field at block 250 and repeats the polling loop by repeating the above steps illustrated in blocks 210-240.

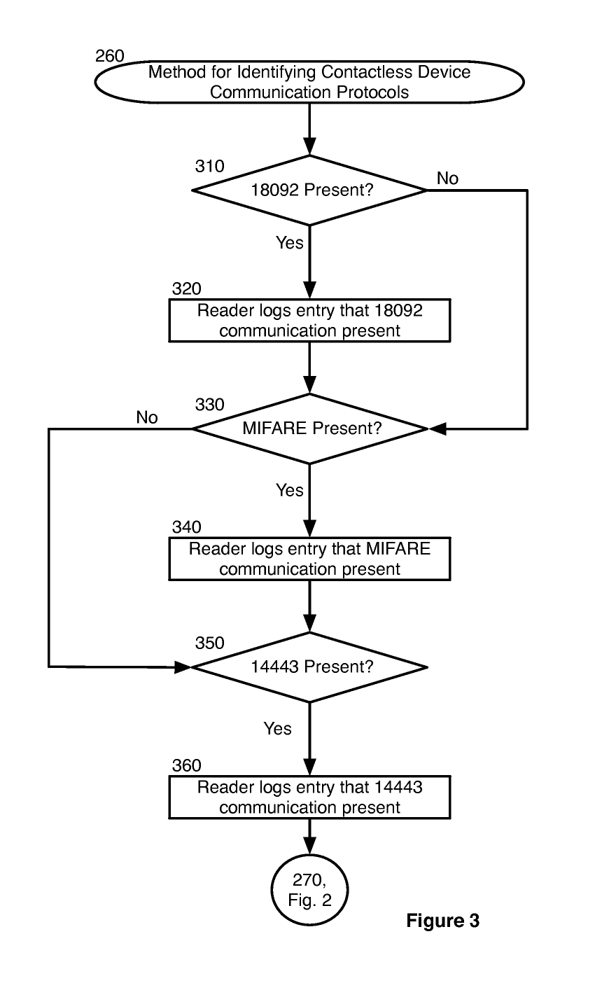

When only a single contactless device 120 is detected, the device reader 115 identifies the contactless device's 120 communication protocols at block 260, based on the information provided by the contactless device 120 in block 240. The identification of the contactless device's communication protocols is described in more detail hereinafter with reference to the methods described in FIG. 3.

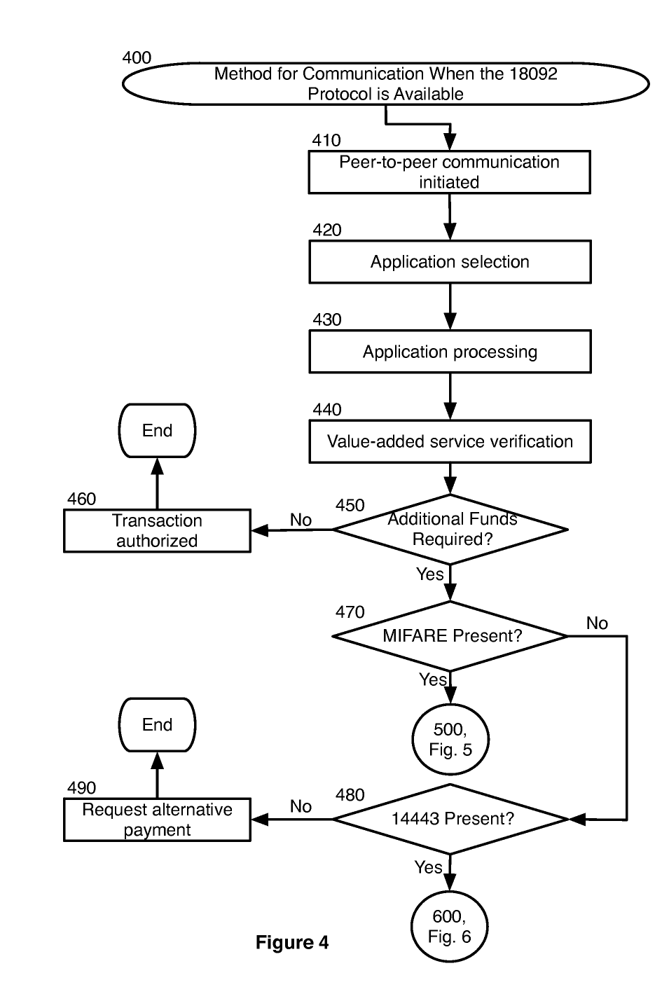

In block 270, the device reader 115 starts multiple communication protocols with the contactless device 120. If the ISO 18092 protocol is available at block 275, communication is initiated first using this protocol. The device reader then initiates another communication protocol thereafter. The method for communicating when ISO 18092 is available is described in further detail hereinafter with reference to the methods described in FIG. 4.

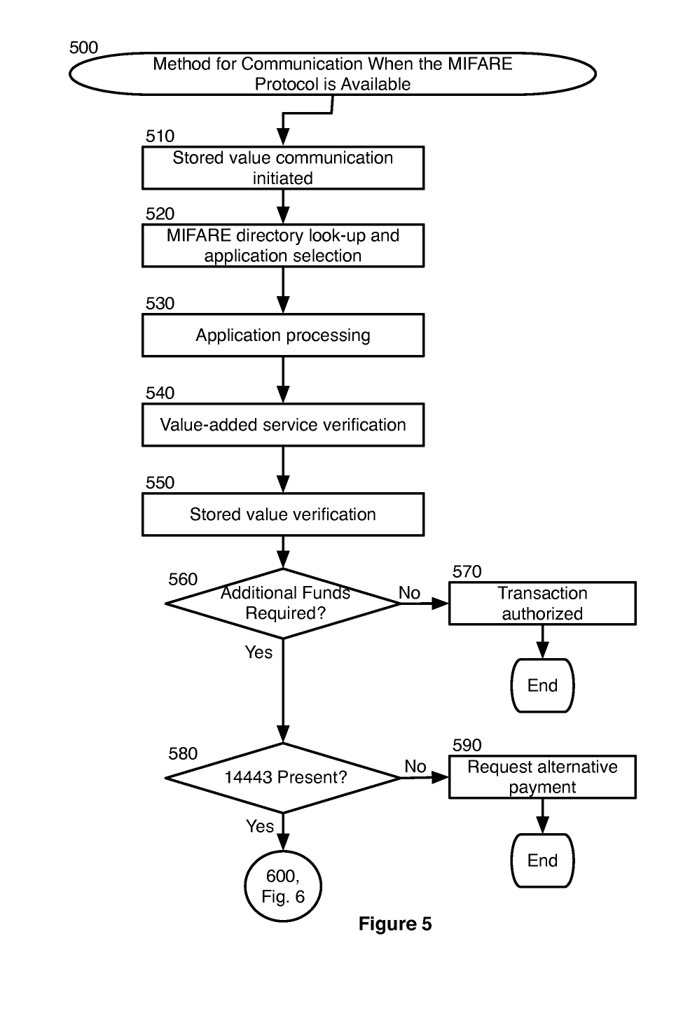

If the ISO 18092 protocol is not available at block 275, the device reader 115 determines if MIFARE is present at block 280. If the MIFARE protocol is available at block 280, communication is initiated using this protocol. The device reader then initiates another communication protocol thereafter. The method for communicating when MIFARE is available is described in further detail hereinafter with reference to the methods described in FIG. 5.

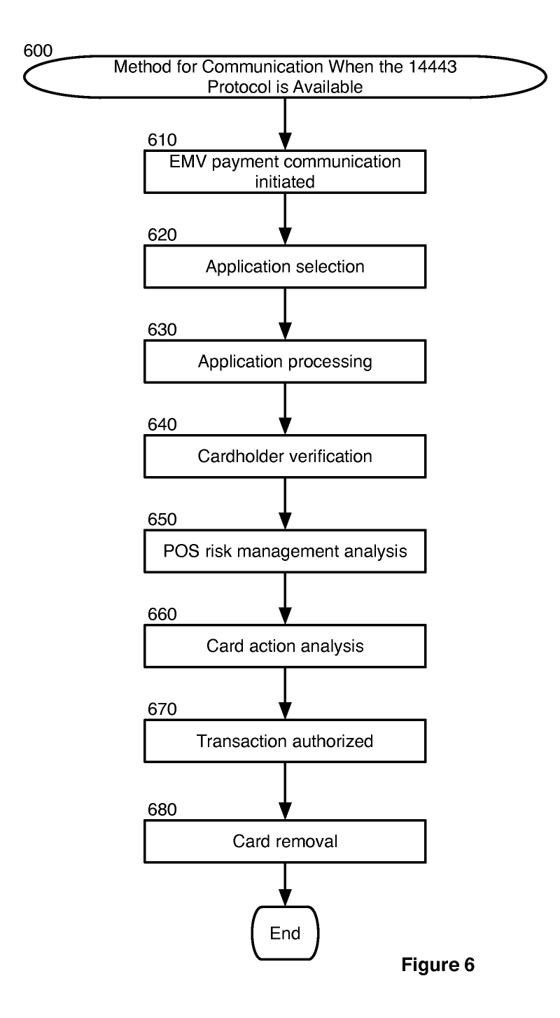

If the MIFARE protocol is not available at block 280, the device reader 115 determines if the ISO 14443 protocol is present at block 285. If the ISO 14443 protocol is available at block 285, communication is initiated using this protocol. The method for communicating when ISO 14443 is available is described in further detail hereinafter with reference to the methods described in FIG. 6.

FIG. 3 is a block flow diagram depicting a method 260 for identifying contactless device communication protocols according to an exemplary embodiment, as referenced in block 260 of FIG. 2. The method 260 is described with reference to the components illustrated in FIG. 1.

At block 310, the device reader 115 determines if the ISO 18092 communication protocol is available to the contactless device 120. In an exemplary embodiment, the device reader 115 reviews the list of communication protocols provided by the contactless device 120 at block 240 to make this determination.

If the ISO 18092 protocol is available, the device reader logs an entry that the protocol is available at block 320.

From block 320, the method 260 proceeds to block 330. Referring back to block 310, if the ISO 18092 protocol is not available, the method 260 proceeds directly to block 330.

At block 330, the device reader 115 determines if the MIFARE communication protocol is available to the contactless device 120. In an exemplary embodiment, the device reader 115 reviews the list of communication protocols provided by the contactless device 120 at block 240 to make this determination.

If the MIFARE protocol is available, the device reader logs an entry that the protocol is available at block 340.

From block 340, the method 260 proceeds to block 350. Referring back to block 330, if the MIFARE protocol is not available, the method 260 proceeds directly to block 350.

At block 350, the device reader 115 determines if the ISO 14443 communication protocol is available to the contactless device 120. In an exemplary embodiment, the device reader 115 reviews the list of communication protocols provided by the contactless device 120 at block 240 to make this determination.

If the ISO 14443 protocol is available, the device reader logs an entry that the protocol is available at block 360.

In an exemplary embodiment, the device reader 115 then starts multiple communication protocols with the contactless device 120, as described with reference to block 270 of FIG. 2. The methods for communicating with the contactless device via multiple communication protocols are described in further detail hereinafter with reference to the methods described in FIGS. 4-6.

FIG. 4 is a block flow diagram depicting a method 400 for communication when the ISO 18092 protocol is available according to an exemplary embodiment. The method 400 is described with reference to the components illustrated in FIG. 1.

If the device reader 115 determines that the ISO 18092 communication protocol is available at block 310, the device reader 115 initiates a peer-to-peer communication via ISO 18092 with the contactless device 120 at block 410. In an exemplary embodiment, the ISO 18092 communication protocol enables richer communication between the device reader 115 and the contactless device 120, allowing for communication at higher bit rates and allowing for buffering and retries compared to communication with other protocols (for example, MIFARE and ISO 14443). In an exemplary embodiment, the communication protocol utilizes a logical link control protocol (LLCP). In another embodiment, the ISO 18092 communication protocol enables communication directly to the contactless device application 122, not the secure element 126. In an exemplary embodiment, an ISO 18092 communication protocol enables peer-to-peer communication, value-added services (including, but not limited to, coupons, loyalty cards, check-ins, membership cards, gift cards, and other forms of value-added services), and other forms of richer communication. In block 420, the device reader 115 selects an application 122 from the contactless device 120. In an exemplary embodiment, the device reader 115 selects an application from the list generated in block 240. Selection of the application 122 may be dependent on the type of peer-to-peer communication initiated. In an exemplary embodiment, the device reader 115 selects an application 122 to process a specified value-added service, for example, loyalty cards, reward cards, coupons, check-ins, gift cards and other forms of value-added services.

In block 430, the application 122 processes the communication from the device reader 115 and verifies the value-added service at block 440. In an exemplary embodiment, the device reader 115 provides the application 122 with data it requests to process the communication. The application 122 will provide the device reader 115 with data records used to verify the transaction. In an exemplary embodiment, more than one application can be selected and processed. In another exemplary embodiment, more than one type of value-added service can be verified.

Exemplary value added services can be embodied in one or more value added applications residing on the contactless device 120 (for example, in the application 122) and/or within the secure element 126. Value added applications can perform functionality to redeem the value added services.

For example, a value added coupon application can automatically redeem coupons stored in the value added coupon application. More specifically, a user may save one or more coupons (or other “offers”) to the value added service coupon application on the contactless device 120. When the value added application processing is performed in block 430, the value added coupon can be applied to the transaction. For example, the value added coupon application can search stored coupons that can be applied to the current transaction. This determination can be based on an identity of the merchant and products being purchased, as provided by the device reader 115 to the contactless device 120. Alternatively, or additionally, merchant information can be determined by the value added coupon application based on geocode information available to the contactless device 120 by comparing the geocode information for the current location of the device 120 with known merchant locations. After identifying coupons that can apply to the merchant or products, the value added coupon application communicates the coupon(s) to the device reader 115 via the antenna 129. Thereafter, the POS terminal 110 processes the coupon for the transaction. If multiple coupons apply to the transaction, the value added service application can determine which coupon offers the greatest value and/or which combination of coupons offers the greatest value and can automatically apply the greatest value choice.

As another example, a value added loyalty application can automatically collect and redeem loyalty rewards. More specifically, a user may install a loyalty application for a particular merchant (or a loyalty application that operates for multiple merchants). Each time a transaction is conducted with the merchant, the value added loyalty application collects loyalty rewards (for example, points, number of visits, number of items purchased, or other suitable reward). Then, when sufficient loyalty rewards have been collected to redeem for value, the value added loyalty application can automatically apply the redemption. For example, when the value added application processing is performed in block 430, the value added loyalty rewards can be accumulated and/or applied to the transaction. For example, the value added loyalty application can search accumulated rewards that can be applied to the current transaction. This determination can be based on an identity of the merchant and products being purchased, as provided by the device reader 115 to the contactless device 120. Alternatively, or additionally, merchant information can be determined by the value added loyalty application based on geocode information available to the contactless device 120 by comparing the geocode information for the current location of the device 120 with known merchant locations. After identifying loyalty rewards that can be redeemed for the merchant or products, the value added loyalty application communicates the loyalty reward(s) to the device reader 115 via the antenna 129. Thereafter, the POS terminal 110 processes the loyalty rewards for the transaction. If loyalty rewards are not available for redemption, the value added loyalty application communicates a request to accumulate loyalty rewards to the device reader 115 via the antenna 129. Thereafter, the POS terminal 110 processes the transaction and communicates the loyalty rewards for the transaction from the device reader 118 to the contactless device 120. The value added loyalty application increments the stored loyalty rewards accordingly for future redemption.

Other value added applications can be implemented in a similar manner, for example, check-ins, membership cards, gift cards, and other forms of value-added services. Corresponding value added service applications can function to determine whether the particular service applies to the transaction (for example, to the merchant or the product) and to apply the service to the transaction if appropriate. For instance, a gift card having value stored thereon can be applied to the transaction.

In this manner, multiple value added services can be applied in block 430. The application 122 can process each available value added service application to thereby apply all available value added services to the transaction. Additionally, if multiple value added services apply to the transaction, the application 122 can determine which service offers the greatest value and/or which combination of services offers the greatest value and can automatically apply the greatest value choice.

After the value-added services are verified at block 440 based on complete on those services, the POS terminal 110 determines if additional funds are required to complete the transaction at block 450. In exemplary embodiments, additional funds may not be required if the value added service(s) are sufficient to complete the transaction. For example, a coupon, loyalty redemption, or stored-value card or any individual or combination of value added services may be sufficient for the entire cost of the transaction.

If additional funds are not required, the transaction is authorized and completed at block 460. Completion of the transaction at block 460 encompasses the POS terminal 110 communicating a receipt to the contactless device 120 via the device reader 115. The application 122 can display the receipt on the contactless device 120 via the user interface 123. The receipt can identify all items applied to the transaction. For example, the receipt can identify each coupon, loyalty redemption, stored value card, or other value added service applied to the transaction, and may also show items included in the transaction (for example, ticket numbers for tickets purchased). In an exemplary embodiment, a single receipt may show all items applied to the transaction. Alternatively, multiple receipts may be provided, wherein each receipt is for a particular one of the items applied to the transaction.

Referring back to block 450, if additional funds are required, the device reader 115 determines if the MIFARE communication protocols are available at block 470. In an exemplary embodiment, the device reader 115 reviews the log of communications protocols generated in block 260 of FIG. 2 to make this determination. If the MIFARE communication protocol is available, the device reader 115 initiates communication at block 500 via the MIFARE protocol. The method for communicating with the contactless device when the MIFARE protocol is available is described in further detail hereafter with reference to the methods described in FIG. 5.

If the MIFARE communication protocol is not available, the device reader 115 determines if the ISO 14443 communication protocol is available at block 480. In an exemplary embodiment, the device reader 115 reviews the log of communications protocols generated in block 260 of FIG. 2 to make this determination. If the ISO 14443 communication protocol is available, the device reader 115 initiates communication at block 600 via the ISO 14443 protocol. The method for communicating with the contactless device when the ISO 14443 protocol is available is described in more detail hereafter with reference to the methods described in FIG. 6.

If the ISO 14443 communication protocol is not available, the POS terminal requests an alternative form of payment at block 490 to complete the transaction. In alternative form of payment could comprise cash or physical tender of a payment card.

FIG. 5 is a block flow diagram depicting a method 500 for communication when the MIFARE protocol is available according to an exemplary embodiment. The method 500 is described with reference to the components illustrated in FIG. 1.

If the device reader 115 determines that the MIFARE communication protocol is available at block 330, the device reader 115 initiates a stored value communication with the contactless device 120 at block 510. In an exemplary embodiment, the MIFARE communication protocol enables stored value card payments, such as transit card, gift card, or other stored value card payments. In another embodiment, the MIFARE communication protocol enables access to value added services, such as ticketing, loyalty cards, coupons, public transportation cards, access cards, gaming cards, and other contactless card technology.

In block 520, the device reader 115 selects an application 122 from the contactless device 120. In an exemplary embodiment, the device reader 115 looks at the MIFARE directory (not illustrated) and selects an application 122. In an alternative embodiment, the device reader 115 selects an application from the list generated in block 240. Selection of the application 122 may be dependent on the type of stored value or value added communication initiated. In an exemplary embodiment, the device reader 115 selects an application 122 to process a specified stored value card, for example, a gift card, transit card, ticket, access card, loyalty card, or other form of stored value card transaction.

In block 530, the application 122 processes the communication from the device reader 115 and verifies any value-added services at block 540 and any stored value service at block 550. In an exemplary embodiment, the device reader 115 provides the application 122 with data it requests to process the communication. The application 122 will provide the device reader 115 with data records used to verify the transaction. In an exemplary embodiment, more than one application can be selected and processed. In another exemplary embodiment, more than one type of stored value service can be processed and verified. In another embodiment, more than one type of value-added service can be processed and verified. The value added and stored value transaction processing may be similar to the processing described with reference to block 430 of FIG. 4.

After the value-added and stored value services are verified at blocks 540 and 550, the device reader determines if additional funds are required to complete the transaction at block 560, similarly to the process described with reference to block 450 of FIG. 4.

If additional funds are not required, the transaction is authorized and completed at block 570. Completion of the transaction at block 570 encompasses the POS terminal 110 communicating a receipt to the contactless device 120 via the device reader 115, similarly to the process described with reference to block 460 of FIG. 4.

If additional funds are required at block 560, the device reader 115 determines if the ISO 14443 communication protocol is available at block 580. In an exemplary embodiment, the device reader 115 reviews the log of communications protocols generated in block 260 of FIG. 2 to make this determination. If the ISO 14443 communication protocol is available, the device reader 115 initiates communication at block 600 via the ISO 14443 protocol. The method for communicating with the contactless device when the ISO 14443 protocol is available is described in further detail hereinafter with reference to the methods described in FIG. 6.

If the ISO 14443 communication protocol is not available, the POS terminal requests an alternative form of payment at block 590, similarly to the process described with reference to block 490 of FIG. 4.

FIG. 6 is a block flow diagram depicting a method 600 for communication when the ISO 14443 protocol is available according to an exemplary embodiment. The method 600 is described with reference to the components illustrated in FIG. 1.

If the device reader 115 determines that the ISO 14443 communication protocol is available at block 350, the device reader 115 initiates an EMV value communication with the contactless device 120 at block 610. In an exemplary embodiment, the ISO 14443 communication protocol enables secure credit or debit card payments using the secure payment information stored in the secure element 126 of the contactless device 120.

In block 620, the device reader 115 selects an application 127 from the secure element 126 of the contactless device 120. In an exemplary embodiment, the device reader 115 selects an application from the list generated in block 240 of FIG. 2. In another embodiment, the device reader 115 generates a list of applications that are supported by the POS terminal 110 and the contactless device 120. If multiple applications 122 are available, the user may be prompted to select an application or the application 127 may be automatically selected. The selected application 127 allows processing of a secure payment card.

In block 630, the application 122 processes the communication from the device reader 115 and verifies the cardholder at block 640. In an exemplary embodiment, the device reader 115 provides the application 122 with data requests to process the communication. The application 127 will provide the device reader 115 with data records used to verify the transaction. In an exemplary embodiment, the cardholder is asked to enter, via the user interface 123, a personal identification number (PIN) to verify the cardholder. In another embodiment, the cardholder is asked to provide a signature to the device reader 115 for verification. In yet another exemplary embodiment, PIN or signature verification is not required. For example, activation of the application 122 that prepares the secure element 126 for payment transactions provides cardholder verification for the card information stored in the secure element 126.

In block 650, the POS terminal 110 performs a risk management analysis. In an exemplary embodiment, the POS terminal 110 checks the card numbers, cardholder name, and/or expiration date, and/or requests authorization from a payment processor (not illustrated).

In block 660 the POS terminal 110 analyzes the card action. In an exemplary embodiment, the POS terminal 110 determines whether application usage control (AUC) permits the current transaction and/or whether the transaction exceeds any set limits. After passing the verification and analysis steps 640 and 660, the transaction is then authorized in block 670 and the transaction processing is completed via the device reader 115 and the secure element 126. Completion of the transaction at block 670 encompasses the POS terminal 110 communicating a receipt to the contactless device 120 via the device reader 115, similarly to the process described with reference to block 460 of FIG. 4.

In block 680 the device reader 115 turns off the RF field until it determines that the contactless device 120 is no longer in proximity of the device reader 115 or RF field. In an exemplary embodiment, the device reader 115 turns off or resets the RF field to ensure continuous or multiple unsolicited interactions with the contactless device 120 is prevented.

### General

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described herein. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described herein in detail, the description is merely for purposes of illustration. Various modifications of, and equivalent blocks corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A computer-implemented method for providing multiple contactless device interactions and communication protocols, comprising:
detecting via near field communication (NFC) a mobile communication device by a point of sale system reader;
determining, by the reader, a plurality of NFC communication protocols available for the contactless device; and
initiating, by the reader, communications between the reader and the contactless device using the plurality of communication protocols available for the contactless device,
wherein if an ISO/IEC 18092 communication protocol is available, the reader first initiates a communication with the contactless device using the ISO/IEC 18092 protocol, and
wherein, if an ISO/IEC 18092 protocol is not available or after completion of the communication with the contactless device using the ISO/IEC 18092 protocol, if a MIFARE communication protocol is available, the reader initiates a communication with the contactless device using the MIFARE protocol.

2. The computer-implemented method of claim 1, wherein, if a MIFARE protocol is not available or after completion of the communication with the contactless device using the MIFARE protocol, if an ISO/IEC 14443 communication protocol is available, the reader initiates a communication with the contactless device using the ISO/IEC 14443 protocol.

3. The computer-implemented method of claim 1, wherein the ISO/IEC 18092 communication comprises processing of at least one value-added service.

4. The computer-implemented method of claim 3, wherein the value-added service comprises at least one of a coupon, loyalty card, check-in, membership card, and a stored-value card.

5. The computer-implemented method of claim 1, wherein the MIFARE communication comprises processing of at least one value-added service communication.

6. The computer-implemented method of claim 5, wherein the MIFARE communication comprises processing of a stored-value card transaction.

7. The computer-implemented method of claim 1, wherein the contactless device is a mobile telephone.

8. A computer-implemented method for communicating with a contactless device, comprising:
opening a polling loop by a device reader and generating a radio frequency (RF) field;
requesting, by the reader communication protocols and applications from a contactless device placed within the RF field
determining, by the reader, if an ISO/IEC 18092 communication protocol is available for the contactless device;
determining, by the reader, if a MIFARE communication protocol is available for the contactless device;
determining, by the reader, if an ISO/IEC 14443 communication protocol is available for the contactless device;
initiating, by the reader, first a communication with the contactless device using the ISO/IEC 18092 communication protocol if the ISO/IEC 18092 communication protocol is available for the contactless device;
thereafter, or if the ISO/IEC 18092 communication protocol is not available for the contactless device, initiating, by the reader, a communication with the contactless device using the MIFARE communication protocol if the MIFARE communication protocol is available for the contactless device; and
thereafter, or if the MIFARE communication protocol is not available for the contactless device, initiating, by the reader, a communication with the contactless device using the ISO/IEC 14443 communication protocol.

9. The computer-implemented method of claim 8, wherein the ISO/IEC 18092 communication comprises processing of a value-added service.

10. The computer-implemented method of claim 9, wherein the value-added service comprises at least one of a coupon, loyalty card, check-in, membership card, and gift card.

11. The computer-implemented method of claim 8, wherein the MIFARE communication comprises processing of a stored-value service.

12. The computer-implemented method of claim 8, wherein the ISO/IEC 14443 communication comprises processing a secure payment transaction.

13. The computer-implemented method of claim 8, wherein the contactless device is a mobile telephone.

14. A computer-implemented method for processing transactions between a point of sale system and a contactless device, comprising:
detecting, via near field communication by a point of sale system reader, a “tap” of a mobile communication device to the reader;
conducting, during the tap and by the reader, a value added service via a first communication protocol and thereafter a secure payment transaction via a second communication protocol.

15. The computer-implemented method of claim 14, wherein the first communication protocol is ISO/IEC 18092, and wherein the second communication protocol is ISO/IEC 14443.

16. The computer-implemented method of claim 14, wherein the first communication protocol is MIFARE, and wherein the second communication protocol is ISO/IEC 14443.

17. The computer-implemented method of claim 14, wherein the contactless device is a mobile telephone.

18. A computer-implemented method for processing transactions between a point of sale system and a contactless device, comprising:
detecting, via near field communication by a point of sale system reader, a “tap” of a mobile communication device to the reader;
conducting, during the tap and by the reader, a plurality of value added services via a first communication protocol and thereafter a secure payment transaction via a second communication protocol.

19. The computer-implemented method of claim 18, wherein the first communication protocol is ISO/IEC 18092, and wherein the second communication protocol is ISO/IEC 14443.

20. The computer-implemented method of claim 18, wherein the first communication protocol is MIFARE, and wherein the second communication protocol is ISO/IEC 14443.

21. The computer-implemented method of claim 18, wherein the value-added services comprise at least two of a coupon, loyalty card, check-in, membership card, and a stored-value card.

22. The computer-implemented method of claim 18, wherein the contactless device is a mobile telephone.
